(19) United States
(12) Patent Application Publication
(10) Pub. No.: US 2009/0233013 A1
(43) Pub. Date: Sep. 17, 2009

(54) VIEWING WINDOW AND ELECTRONIC DEVICE EMPLOYING THE SAME

(75) Inventors: TAO FU, Shenzhen City (CN); AN-CHUN ZHANG, Shenzhen City (CN); XUE-WEN XIE, Shenzhen City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/133,491

(22) Filed: Jun. 5, 2008

(30) Foreign Application Priority Data
Feb. 29, 2008 (CN) 200810300433.3

(51) Int. Cl. B44F 7/00; B32B 3/10; B32B 3/00; B32B 5/16; B32B 3/02; G06F 1/16

(52) U.S. Cl. 428/13; 428/147; 428/201; 428/203; 428/204

(57) ABSTRACT

An electronic device (100) employs a viewing window (10), which includes a transparent substrate (11), an ink layer (12) and a metal layer (14). The ink layer is made of semitransparent ink or transparent matte ink. The ink layer is formed on the substrate and partially covers the substrate; and the metal layer is formed on the ink layer.

### BACKGROUND OF THE INVENTION

1. Field of the Invention

The present invention relates to viewing windows and electronic devices employing the same, particularly to a viewing window having a three-dimensional visual effect and an electronic device employing the same.

2. Description of Related Art

Nowadays, portable electronic devices such as mobile phones, laptops and personal digital assistants (PDA) are widely used. Generally, a portable electronic device includes at least one display, which is protected by a viewing window.

In use, an ink layer is often printed on a periphery of the viewing window to decorate the electronic device or form a logo. However, the printed ink layer is a planar design and not a three-dimensional effect that would make the electronic device more attractive.

Therefore, a new viewing window and a new electronic device employing the same are desired in order to overcome the above-described shortcomings.

### BRIEF DESCRIPTION OF THE DRAWINGS

Many aspects of the present viewing window and electronic device employing the same can be better understood with reference to the following drawings. The components in the various drawings are not necessarily drawn to scale, the emphasis instead being placed upon clearly illustrating the principles of the present viewing window and electronic device employing the same. Moreover, in the drawings, like reference numerals designate corresponding parts throughout the diagrams.

FIG. 1 is a schematic view of an electronic device, according to an exemplary embodiment.

FIG. 2 is a schematic view of a viewing window, according to a first embodiment.

FIG. 3 is a cross-sectional view along the line III-III shown in FIG. 2.

FIG. 4 is a cross-sectional view of a viewing window, according to a second exemplary embodiment.

### DETAILED DESCRIPTION OF THE INVENTION

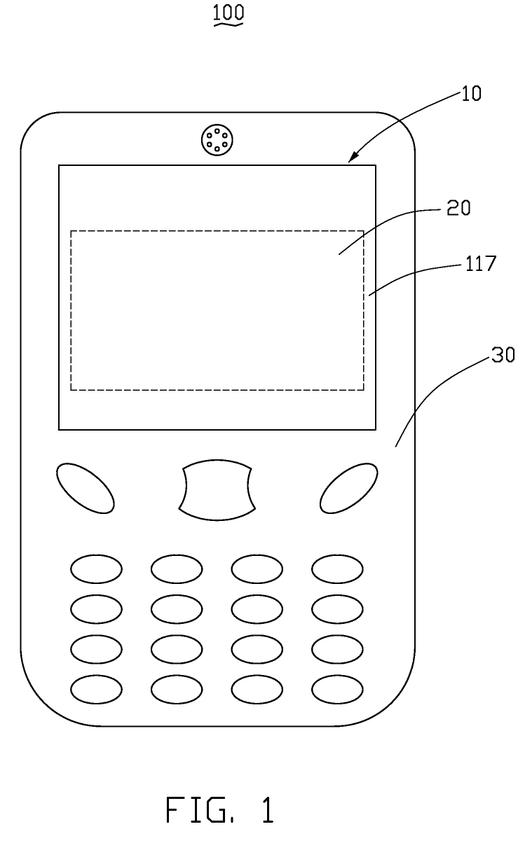

FIG. 1 shows an electronic device according to an exemplary embodiment, such as a mobile phone, a personal digital assistant (PDA), a laptop, etc. The electronic device 100 includes a housing 30, a display 20 and a viewing window 10. The display 20 is received in the housing 30, and the viewing window 10 is assembled on the housing 30 to cover and protect the display 20.

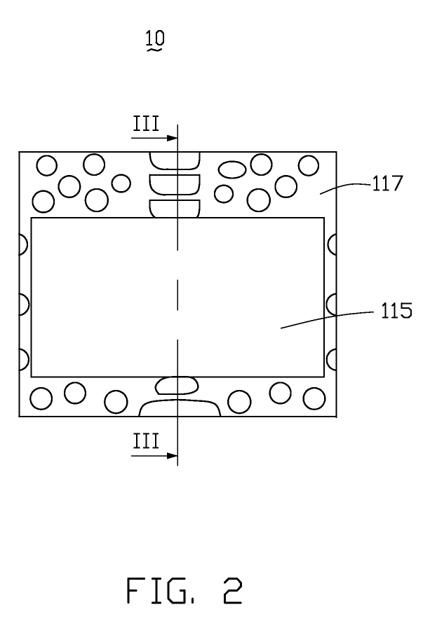

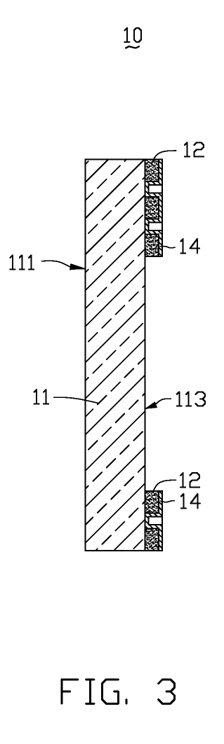

Also referring to FIG. 2 and FIG. 3, the viewing window 10 includes a substrate 11, an ink layer 12 formed on the substrate 11, and a metal layer 14 formed on the substrate 11 and the ink layer 12.

The substrate 11 is made of transparent materials, such as polycarbonate (PC) or polymethyl methacrylate (PMMA). The substrate 11 includes a first surface 111 and an opposite second surface 113. When the viewing window 10 is mounted on the housing 30, the first surface 111 is positioned outward and the second surface 113 is positioned towards the display 20.

The second surface 113 includes a central transparent portion 115 and a peripheral decorating portion 117. The transparent portion 115 has a shape and size corresponding to that of the display 20, thus the display 20 can be displayed via the transparent portion 115. The ink layer 12 and the metal layer 14 are both formed on the decorating portion 117.

The ink layer 12 can be made of semitransparent ink or transparent matte ink. A color of the ink can be changed by means of mixing dye therein. Resin powders, such as acrylic urethane resin powders, and nonmetal powders, such as silica powders, are mixed into the ink to improve a roughness of the ink layer 12. The size of each of these powders is about 30-150 micrometers. The ink layer 12 is formed on the decorating portion 117 via painting or spraying and partially covers the decorating layer 117 to form predetermined designs and/or characters.

The metal layer 14 can be made of aluminum, chrome, nickel, silver, etc. The metal layer 14 is formed on the decorating portion 117 with the ink layer 12 attached thereon by means of depositing, plating, etc., thus covers both the decorating portion 117 and the ink layer 12. A thickness of the metal layer 14 is about 0.5-0.8 micrometer.

In use of the present electronic device 100, a part of the metal layer 14 directly formed on the decorating layer 117 shows a visual effect of a metal mirror, and another part of the metal layer 14 formed on the ink layer 12 having a high roughness shows a visual effect of an etched metal. In this way, when viewed from the first surface 111, the decorating layer 117 has a three-dimensional effect and gets more attraction.

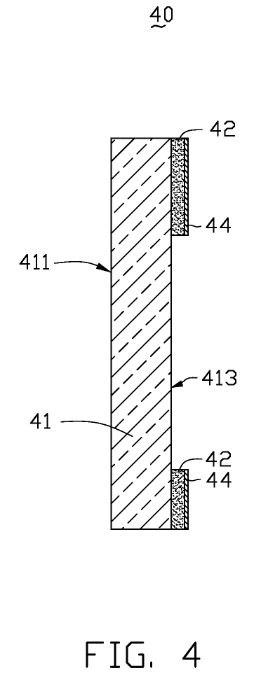

Also referring to FIG. 4, a viewing window 40 according to a second exemplary embodiment is shown. Similarly to the viewing window 10, the viewing window 40 includes a substrate 41, an ink layer 42 formed on the substrate 41 and a metal layer 44 formed on the ink layer 42. The substrate 41, the ink layer 42 and the metal layer 43 are respectively made of materials similar to that of the substrate 11, the ink layer 12 and the metal layer 14.

Similarly to the substrate 11, the substrate 41 includes a first surface 411 and an opposite second surface 413 which includes a central transparent portion (not labeled) and a peripheral decorating portion (not labeled). The ink layer 42 is formed on the decorating portion. Unlike with the viewing window 10, in the viewing window 40, the ink layer 42 covers the whole decorating portion, and the metal layer 44 is formed on the ink layer 42 and covers the whole ink layer 42. In use, the viewing window 40 is assembled on the housing 30, the second surface 413 is positioned towards the display 20 received in the housing 30 and the first surface 411 is positioned towards outside. Viewed from the first surface 411, the decorating layer of the viewing window 40 has a visual effect of an etched metal and gets more attraction.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A viewing window, comprising:
a transparent substrate;
an ink layer made of semitransparent ink or transparent matte ink, the ink layer being formed on the substrate and partially covering the substrate; and
a metal layer formed on the ink layer and at least covering the portions of the substrate not covered by the ink layer.

2. The viewing window as claimed in claim 1, wherein the substrate includes a first surface and an opposite second surface including a transparent portion and a decorating portion, the ink layer being formed on the decorating portion.

3. The viewing window as claimed in claim 2, wherein the ink layer partially covers the decorating portion, and the metal layer covers both the ink layer and the decorating portion.

4. The viewing window as claimed in claim 2, wherein the ink layer covers the whole decorating portion, and the metal layer covers the ink layer.

5. The viewing window as claimed in claim 1, wherein resin powders and nonmetal powders are mixed into the ink layer.

6. The viewing window as claimed in claim 5, wherein size of the resin powders and the nonmetal powders is about 30-150 micrometers.

7. The viewing window as claimed in claim 1, wherein the metal layer is made of materials selected in a group consisting of aluminum, chrome, nickel and silver, and a thickness of the metal layer is about 0.5-0.8 micrometer.

8. An electronic device, comprising;
a housing;
a display received in the housing; and
a viewing window assembled on the housing and covering the display, the viewing window including a transparent substrate, an ink layer formed on the substrate and partially covering the substrate, and a metal layer formed on the ink layer and at least covering the portions of the substrate not covered by the ink layer; wherein the ink layer is made of semitransparent ink or transparent matte ink.

9. The electronic device as claimed in claim 8, wherein the substrate includes a first surface, and an opposite second surface positioned towards the display and including a transparent portion and a decorating portion, the ink layer being formed on the decorating portion.

10. The viewing window as claimed in claim 9, wherein the ink layer partially covers the decorating portion, and the metal layer covers both the ink layer and the decorating portion.

11. The viewing window as claimed in claim 9, wherein the ink layer covers the whole decorating portion, and the metal layer covers the ink layer.

12. The viewing window as claimed in claim 8, wherein resin powders and nonmetal powders are mixed into the ink layer.

13. The viewing window as claimed in claim 12, wherein size of the resin powders and the nonmetal powders is about 30-150 micrometers.

14. The viewing window as claimed in claim 8, wherein the metal layer is made of materials selected in a group consisting of aluminum, chrome, nickel and silver, and a thickness of the metal layer is about 0.5-0.8 micrometer.
